(19) United States
(12) Patent Application Publication
(10) Pub. No.: US 2018/0064098 A1
(43) Pub. Date: Mar. 8, 2018

(54) PORTABLE ANIMAL DECOY

(71) Applicant: Flint Holdings, LLC, Hummelstown, PA (US)

(72) Inventors: CJ Davis, Edgefield, SC (US); Jerry McPherson, Colstrip, MT (US)

(21) Appl. No.: 15/259,642

(22) Filed: Sep. 8, 2016

(51) Int. Cl. A01M 31/06

(52) U.S. Cl. CPC A01M 31/06

(57) ABSTRACT

A bird decoy includes a simulated bird with an internally sewn mounting post sleeve. A mounting post may be inserted into the mounting post sleeve and into a mounting post receptacle of a stand. The stand may also include a horizontal base with a plurality of rod receptacles. A plurality of ground support rods may be inserted into the plurality of rod receptacles for use during hunting or removed for transportation. A plurality of elastic retaining cords may be used to connect the ground support rods with the rod receptacles while allowing the ground support rods engagement and disengagement with the rod receptacles. The stand may also include a spring biased latch that may be used to keep the mounting post receptacle in a vertical position or allow the mounting post receptacle to pivot down for easier transportation of the bird decoy.

### FIELD OF THE INVENTION

The invention is an animal decoy that is easy to break-down for transportation, easy to set-up and move in the field (even on hard or rocky ground) and prevents pieces of the animal decoy from being lost.

### BACKGROUND

Animal decoys may be used to attract animals and to hide the hunter while hunting. When hunting game birds, such as ducks, geese, and turkeys, bird decoys which resemble the two or three-dimensional shape and coloration of the desired game bird may be utilized. To achieve a decoy with a three-dimensional shape, solid or compressible decoys may be used. The solid decoys may have a molded outer surface created to mimic the real appearance of the animal being decoyed. Alternatively, the collapsible decoys may have an outer surface of the decoy with a printed picture showing a real depiction of an animal in order to mimic the appearance of the animal being decoyed.

Animal decoys may be positioned in the ground through the use of a mounting post. The mounting post may be a stake which may include a perpendicular side piece that allows the user to press with his foot or hand in order to push the mounting post into the ground. The decoy may then be attached to the top of the mounting post.

Once staked to the ground, present decoys are not easily moved by the hunter. It would be desirable to have an animal decoy that is easy to break-down for transportation, easy to set-up and move in the field (even on hard or rocky ground) and prevents pieces of the animal decoy from being lost.

### SUMMARY

A bird decoy may include a simulated bird. The simulated bird may include a mounting post sleeve, preferably sewn into the interior of the simulated bird. A first end of a mounting post may be inserted into the mounting post sleeve of the simulated bird.

The bird decoy may also include a stand. The stand may include a mounting post receptacle configured to receive the second end of the mounting post and may be pivotally connected to a horizontal base.

The stand may also include the horizontal base that has a plurality of rod receptacles and a latch receptacle. The stand may also include a plurality of ground support rods configured to be inserted into the plurality of rod receptacles. In preferred embodiments, all of the ground support rods extend radially away from the horizontal base within a 60 degree to 180 degree arc while there are no ground support rods extending radially away from the horizontal base outside of the 60 degree to 180 degree arc. Grouping the ground support rods together allows the bird decoy to be more easily slid along the ground during use.

In some embodiments, a plurality of elastic retaining cords may be used to bias or provide tension so each ground support rod remains in its corresponding rod receptacle. The elastic retaining cords may be sufficiently elastic to permit a user to remove a ground support rod from its corresponding rod receptacle by hand and without any tools, to thereby break-down the stand for easier transportation.

The stand may also comprise a spring biased latch attached to an outside surface of the mounting post receptacle. In preferred embodiments, the spring biased latch is configured to retain the mounting post receptacle between a 60 degree and a 120 degree position in relation to the horizontal base when an end of the spring biased latch is inserted in the latch receptacle of the horizontal base and the spring biased latch is configured to enable the mounting post receptacle to pivot with respect to the horizontal base when the spring biased latch is not inserted in the latch receptacle of the horizontal base.

### BRIEF DESCRIPTION OF THE DRAWINGS

The detailed description is set forth with reference to the accompanying figures. The use of the same reference numbers in different figures indicates similar or identical items or features.

FIG. 1 illustrates a side view of a simulated bird, a mounting post and a stand. A plurality of ground support rods are not engaged in their corresponding plurality of rod receptacles and are thus ready to be broken-down in preparation for transportation. A latch is engaged with a latch receptacle so that the mounting post receptacle is perpendicular to a horizontal base.

FIG. 2 illustrates a side view of a simulated bird, a mounting post and a stand. A plurality of ground support rods are engaged in their corresponding plurality of rod receptacles and are thus ready to be placed on the ground for use. A latch is not engaged with a latch receptacle so that the mounting post receptacle is pivotal with respect to a horizontal base.

FIG. 3 illustrates when a latch is not engaged with a latch receptacle so that the mounting post receptacle is pivotal with respect to a horizontal base.

FIG. 4 illustrates when a latch is engaged with a latch receptacle so that the mounting post receptacle is perpendicular to a horizontal base.

FIG. 5 illustrates a plurality of ground support rods that are engaged in their corresponding plurality of rod receptacles and are thus ready to be placed on the ground for use.

FIG. 6 illustrates a horizontal base and a plurality of ground support rods that are not engaged in their corresponding plurality of rod receptacles. As shown, the plurality of ground support rods may be gathered together, thereby making the bird decoy, and specifically the stand, easier to transport to and from the field.

FIG. 7 illustrates a horizontal base and a plurality of ground support rods (the ground support rods are only partially shown) that are engaged in their corresponding plurality of rod receptacles. This embodiment illustrates a single ground support rod that extends in the opposite direction of the other plurality of ground support rods. This embodiment also illustrates a latch with a cotter pin engaged so that the mounting post receptacle is perpendicular to the horizontal base. The cotter pin may be removed so that the mounting post receptacle is pivotal with respect to the horizontal base for easy transport.

### DETAILED DESCRIPTION

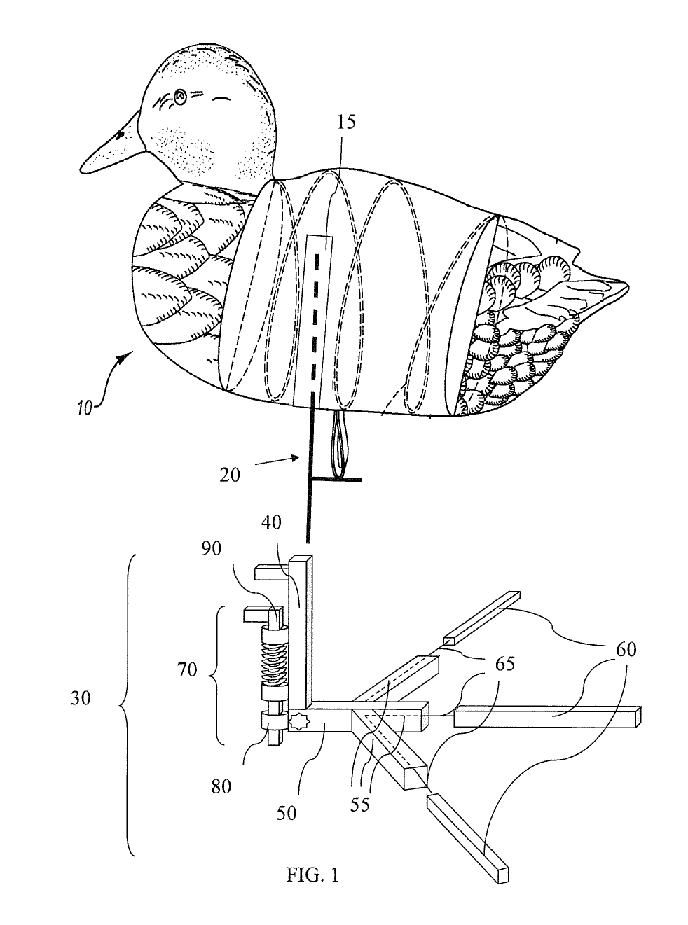

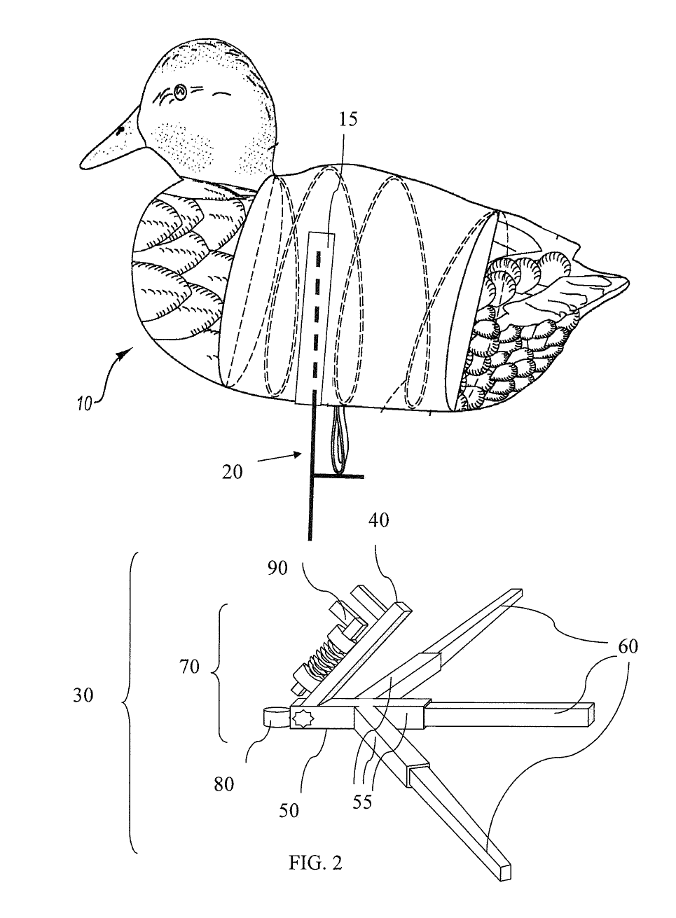

With reference to FIGS. 1 and 2, a bird decoy is illustrated. While the invention will generally be described using an embodiment that comprises a simulated bird 10, other embodiments may include other types of simulated animals.

When a simulated bird 10 is used, the bird decoy may have an exterior that realistically represents a specific type of bird. The realistic representation of the type of bird may be attained in a number of different ways. For example, the bird decoy may have a solid exterior that is molded and colored to resemble a type of bird. As another example, the bird decoy may have a soft fabric exterior and the soft fabric exterior may be imprinted with a realistic representation of a type of bird. Such a simulated bird 10 could be either a two or three-dimensional representation of a type of bird.

The simulated bird 10 may include one or more mounting post sleeves that may run along the sides of the simulated bird 10, but are preferably internal to the simulated bird 10. In some embodiments, the mounting post sleeves may be sewn into the internal cavity of the simulated bird 10. The one or more mounting post sleeves may be advantageously positioned within the simulated bird 10 to improve the balance of the bird decoy. As a non-limiting example of improving the balance of the bird decoy, a mounting post sleeve 15 may run through the center of mass of the simulated bird 10.

In addition, the one or more mounting post sleeves may run at various angles through the simulated bird 10. Mounting post sleeves at various angles may be used to position the simulated bird 10 in natural poses. As non-limiting examples, a mounting post sleeve 15 running from the bottom of the simulated bird 10 towards the head of the bird may be used to make it appear the bird decoy is looking up while a mounting post sleeve 15 running from the bottom of the simulated bird 10 towards the tail of the bird may be used to make it appear the bird decoy is looking down, possibly in a feeding position.

The bird decoy may also include a mounting post 20. A first end of the mounting post 20 may be inserted into a mounting post sleeve 15 within the simulated bird 10. The mounting post 20 is preferably about the length of an actual leg of the animal being depicted by the animal decoy. The mounting post 20 may also include an element extending perpendicularly away from the mounting post 20 to allow the simulated bird 10 to be attached, such as by a loop of material, to the mounting post 20. A second end of the mounting post 20 may be sharp so that in some embodiments, the second end of the mounting post 20 may be inserted into the ground to position the bird decoy. However, in preferred embodiments, the second end of the mounting post 20 is inserted into a mounting post receptacle 40 of a stand 30.

The stand 30 may include the mounting post receptacle 40 configured to receive the second end of the mounting post 20. In embodiments where the second end of the mounting post 20 is inserted into the mounting post receptacle 40, it is preferred that no part of the bird decoy is inserted into the ground. These embodiments allow a hunter to easily slide the bird decoy along the ground while possibly hiding behind the bird decoy while hunting. Using the stand 30 also allows the bird decoy to remain upright in conditions where it might be difficult to insert the mounting post 20 into hard or rocky ground.

The stand 30 may also include a horizontal base 50 configured to be placed on the ground and support the bird decoy when the bird decoy is in use. In preferred embodiments, the horizontal base 50 may include a plurality of rod receptacles 55 constructed or manufactured so as to form a single unit. The horizontal base 50 may be made of any durable and/or lightweight material, such as, as non-limiting examples, steel, aluminum, graphite, plastic and/or a composite material.

The stand 30 may also include a plurality of ground support rods 60. The plurality of ground support rods 60 may all extend radially away from the horizontal base 50 within, as non-limiting examples, a 180 degree, a 90 degree or a 60 degree arc. In these embodiments, there are preferably no ground support rods extending radially away from the horizontal base 50 outside of the 180 degree, the 90 degree or the 60 degree arc. The horizontal base 50 with the plurality of rod receptacles 55 and the plurality of ground support rods 60 are preferably positioned on the same plane, when the plurality of ground support rods 60 are in the plurality of rod receptacles 55, so that the stand 30 is stable when placed on flat ground.

Positioning all of the plurality of ground support rods 60 in the same 180 degree, 90 degree or 60 degree arc allows the bird decoy to be easily slid along the ground in the direction opposite of that pointed to by the plurality of ground support rods 60. Ground support rods 60 outside of the 180 degree, 90 degree or 60 degree arc might be facing the direction the bird decoy is being slid and are thus undesirable as those ground support rods 60 would be more likely to catch or be entangled with branches and/or bushes covering the ground.

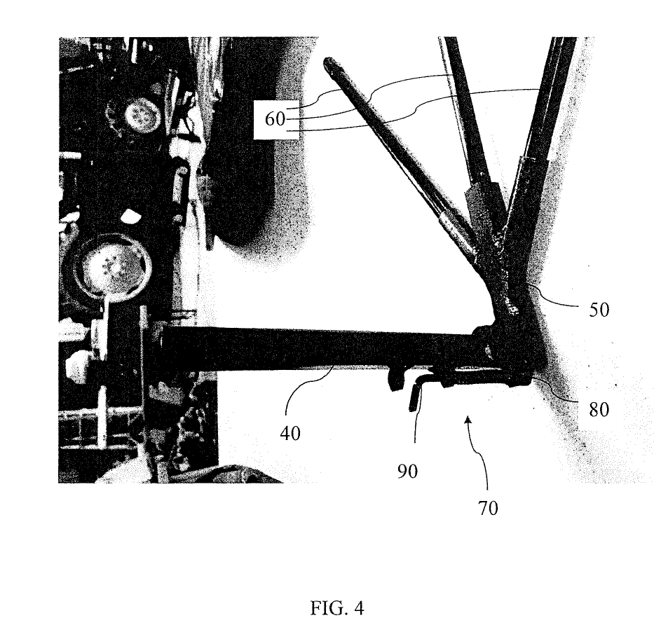

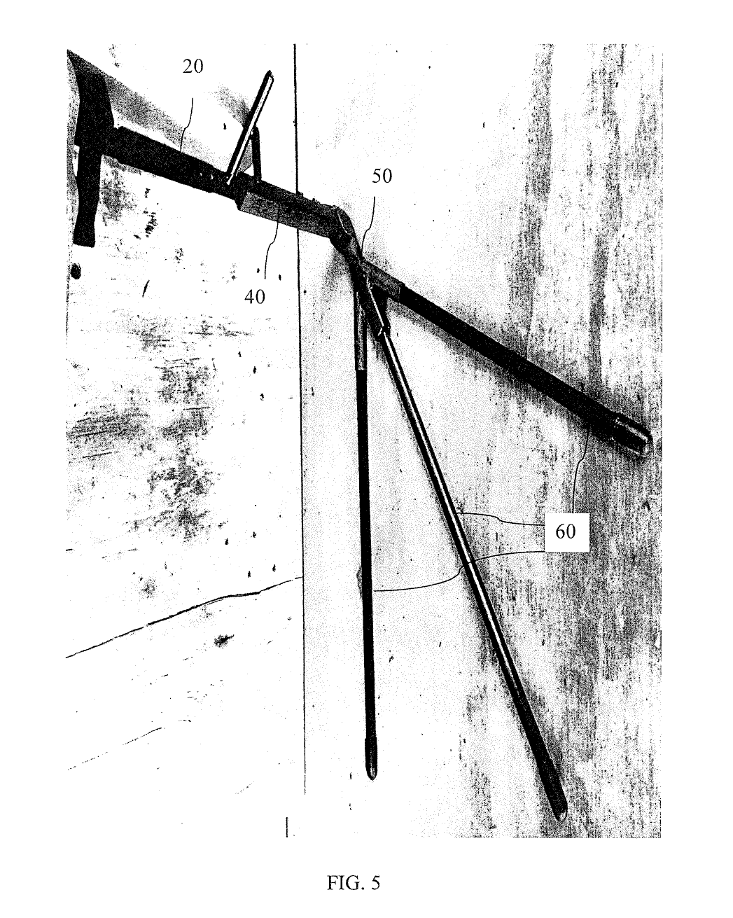

Each ground support rod in the plurality of ground support rods 60 is preferably inserted into a corresponding rod receptacle in the plurality of rod receptacles 55. FIG. 1 illustrates the plurality of ground support rods 60 not being inserted into the plurality of rod receptacles 55 while FIG. 2 illustrates the plurality of ground support rods 60 inserted into the plurality of rod receptacles 55. There is preferably the same number of ground support rods 60 as there are rod receptacles 55. In preferred embodiments, as illustrated in FIGS. 1-5, there are three ground support rods 60 and three corresponding rod receptacles 55.

The stand 30 may also include a plurality of elastic retaining cords 65. In preferred embodiments, each elastic retaining cord 65 has a first end connected to the horizontal base 50 and a second end connected to a ground support rod. Each elastic retaining cord 65 is preferably sufficiently elastic to pull, bias, provide tension and/or retain a ground support rod in a rod receptacle and is also sufficiently elastic so that the ground support rod is removable by hand from the rod receptacle. Each elastic retaining cord 65 is preferably able to be nondestructively stretches at least two inches and may be made from any durable elastic material. In preferred embodiments, each elastic retaining cord 65 runs through a corresponding rod receptacle before being attached to the horizontal base 50. Thus, in the described embodiments, the elastic retaining cords 65 keep their corresponding ground support rods 60 tied to the horizontal base 50 preventing the ground support rods 60 from being lost or misplaced.

The stand 30 may also include a spring biased latch 70 attached to an outside surface of the mounting post receptacle 40. The spring biased latch 70 may be configured to retain the mounting post receptacle 40 in a vertical position in relation to the horizontal base 50 when an end of the spring biased latch 70 is inserted in the latch receptacle 80 of the horizontal base 50 as shown in FIG. 1. The spring biased latch 70 may also be configured to enable the mounting post receptacle 40 to pivot with respect to the horizontal base 50 when the spring biased latch 70 is not inserted in the latch receptacle 80 of the horizontal base 50 as shown in FIG. 2.

In another embodiment, the spring biased latch 70 is configured to retain the mounting post receptacle 40 between a 60 degree and a 120 degree position (and most preferably a 90 degree position) in relation to the horizontal base 50 when an end of the spring biased latch 70 is inserted in the latch receptacle 80 of the horizontal base 50. The spring biased latch 70 may have a spring that biases the latch 90 toward the latch receptacle 80. The spring biased latch 70 may be configured to allow a user to work against the spring and remove the latch 90 from the latch receptacle 80 at the user's discretion. The spring biased latch 70 may also be configured to enable the mounting post receptacle 40 to pivot with respect to the horizontal base 50 when the spring biased latch 70 is not inserted in the latch receptacle 80 of the horizontal base 50. Specifically, there may be a pivot mechanism connecting the mounting post receptacle 40 to the horizontal base 50.

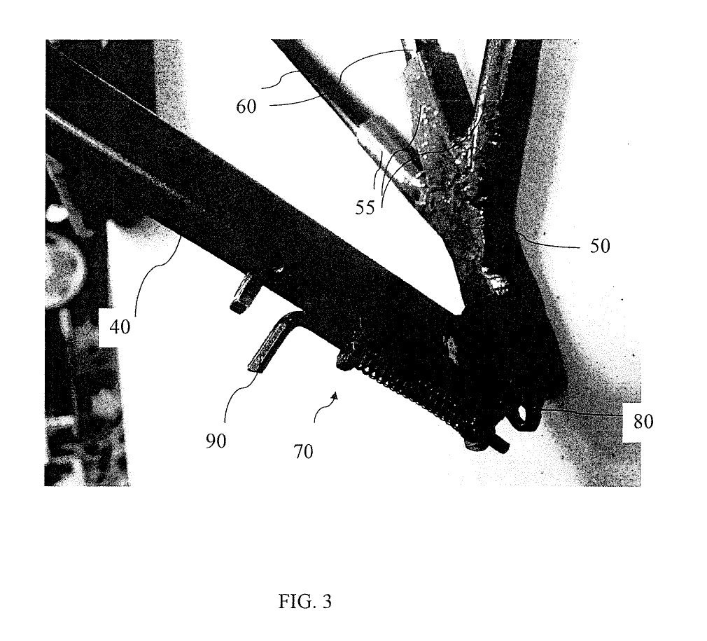

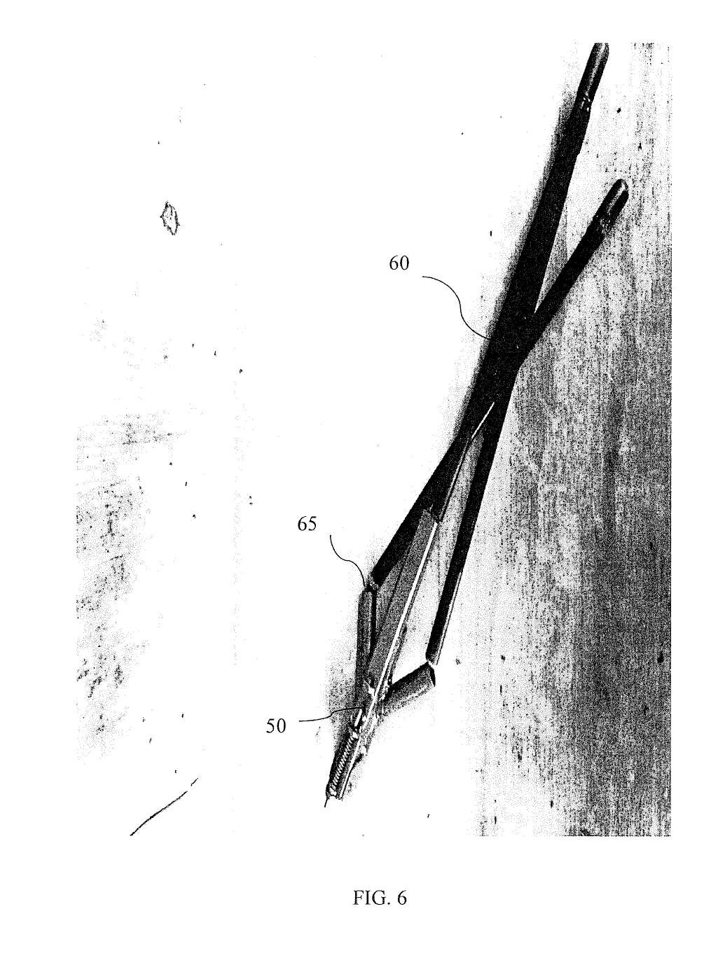

The bird decoy as described is thus very portable. Specifically, the ground support rods 60 may be removed from their corresponding rod receptacles 55 as illustrated in FIGS. 1 and 6 so that the ground support rods 60 may be bunched together, taking much less space, as shown in FIG. 6. In addition, while the latch 90 is preferably engaged with the latch receptacle 80 during use, as shown in FIGS. 1, 4 and 5, the latch 90 may be disengaged with the latch receptacle 80, as shown in FIGS. 2 and 3, during transportation. This allows the mounting post receptacle 40 to be folded down for easier transportation.

While the mounting post receptacle 40 is shown pivotally attached near the end of the horizontal base 50 in FIGS. 1-5, the mounting post receptacle 40 is not so limited and may be pivotally attached to other places on the horizontal base 50. As a non-limiting example, the mounting post receptacle 40 may be pivotally attached to the horizontal base 50 where the plurality of rod receptacles 55 comes together. This embodiment may leave a spur off the back of the horizontal base 50 to attach an elastic strap.

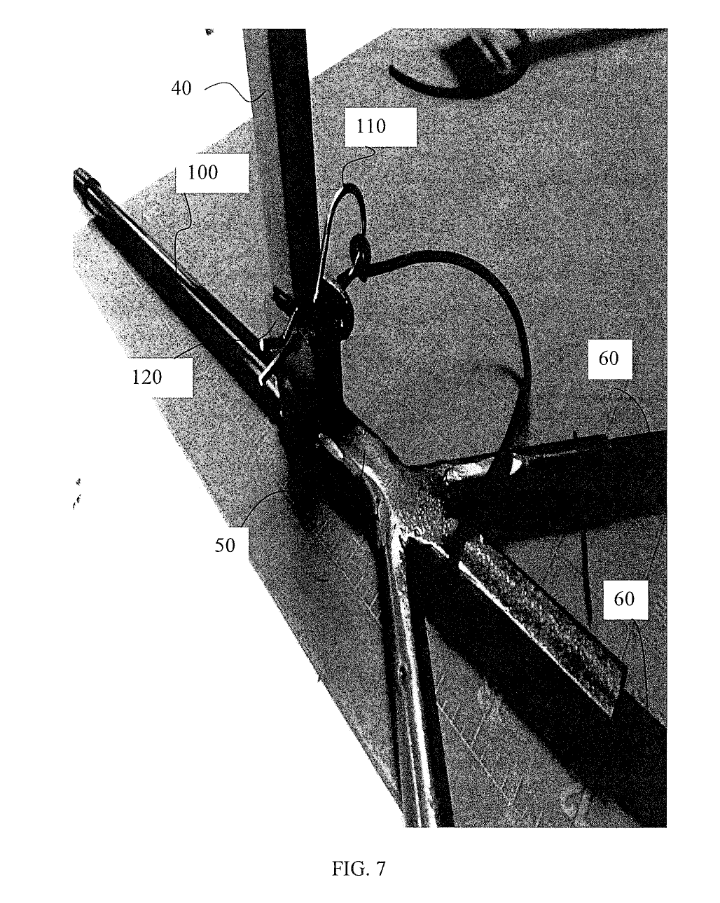

FIG. 7 illustrates a horizontal base 50 and a plurality of ground support rods 60 (the ground support rods 60 are only partially shown in FIG. 7) that are engaged in their corresponding plurality of rod receptacles 55. This embodiment illustrates an additional single ground support rod 100 that extends in the opposite direction of the other plurality of ground support rods 60. This single ground support rod 100 provides additional stability to the bird decoy while still allowing the bird decoy to be slid along the ground during use.

The embodiment in FIG. 7 also illustrates a different type of latch 120 with a cotter pin 110 engaged so that the mounting post receptacle 40 is perpendicular to the horizontal base 50. The cotter pin 110 may be removed so that the mounting post receptacle 40 is pivotal with respect to the horizontal base 50. Removing the cotter pin 110 and pivoting the mounting post receptacle 40 so as to be substantially in alignment with the horizontal base 50 compacts the bird decoy and allows for easier transportation of the bird decoy when not in use. In other embodiments, the cotter pin 110 may be replaced with any other suitable pin, for example a straight pin with a tension button on the end to facilitate attachment and removal of the straight pin.

One skilled in the art will realize that a virtually unlimited number of variations to the above descriptions are possible, and that the examples and the accompanying figures are merely to illustrate one or more examples of implementations.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

It will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments or implementations disclosed, but that such claimed subject matter may also include all embodiments or implementations falling within the scope of the appended claims, and equivalents thereof.

In the detailed description above, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Reference throughout this specification to “one embodiment,” “an embodiment,” “one implementation,” or “an implementation” may mean that a particular feature, structure, or characteristic described in connection with a particular embodiment or implementation may be included in at least one embodiment or implementation of claimed subject matter. Thus, appearances of the phrase “in one embodiment,” “an embodiment,” “one implementation,” or “an implementation” in various places throughout this specification are not necessarily intended to refer to the same embodiment or implementation, or to any one particular embodiment or implementation described. Furthermore, it is to be understood that particular features, structures, or characteristics described may be combined in various ways in one or more embodiments or implementations. In general, of course, these and other issues may vary with the particular context of usage. Therefore, the particular context of the description or the usage of these terms may provide helpful guidance regarding inferences to be drawn for that context.

What is claimed is:

1. A bird decoy comprising:
a simulated bird, wherein the simulated bird includes a mounting post sleeve;
a mounting post having a first end and a second end, wherein the first end of the mounting post is configured to be inserted into the mounting post sleeve of the simulated bird; and
a stand comprising a mounting post receptacle configured to receive the second end of the mounting post, a horizontal base and a plurality of ground support rods, wherein the plurality of ground support rods all extend radially away from the horizontal base within a 90 degree arc and there are no ground support rods extending radially away from the horizontal base outside of the 90 degree arc.

2. The bird decoy of claim 1, wherein no part of the bird decoy is inserted into the ground.

3. The bird decoy of claim 2, wherein the bird decoy is configured to slide along the ground.

4. The bird decoy of claim 1 further comprising:
a plurality of elastic retaining cords, wherein each elastic retaining cord in the plurality of elastic retaining cords comprises a first end connected to the horizontal base and a second end connected to a ground support rod in the plurality of ground support rods.

5. The bird decoy of claim 1, wherein the horizontal base comprises a plurality of rod receptacles configured to receive the plurality of ground support rods.

6. The bird decoy of claim 5 further comprising:
a plurality of elastic retaining cords, wherein each elastic retaining cord in the plurality of elastic retaining cords is sufficiently elastic to pull and retain a ground support rod in the plurality of ground support rods into a rod receptacle in the plurality of rod receptacles and is sufficiently elastic so that the ground support rod is removable by hand from the rod receptacle.

7. The bird decoy of claim 1, wherein the plurality of ground support rods all extend radially away from the horizontal base within a 60 degree arc and there are no ground support rods extending radially away from the horizontal base outside of the 60 degree arc.

8. A bird decoy comprising:
a simulated bird, wherein the simulated bird includes a mounting post sleeve;
a mounting post having a first end and a second end, wherein the first end of the mounting post is configured to be inserted into the mounting post sleeve of the simulated bird; and
a stand comprising:
a mounting post receptacle configured to receive the second end of the mounting post,
a horizontal base comprising a plurality of rod receptacles,
a plurality of ground support rods configured to be inserted into the plurality of rod receptacles, and
a plurality of elastic retaining cords, wherein each elastic retaining cord in the plurality of elastic retaining cords comprises a first end connected to the horizontal base, a length that runs through a rod receptacle and a second end connected to a ground support rod in the plurality of ground support rods.

9. The bird decoy of claim 8, wherein no part of the bird decoy is inserted into the ground.

10. The bird decoy of claim 9, wherein the bird decoy is configured to slide along the ground.

11. The bird decoy of claim 8, wherein each elastic retaining cord in the plurality of elastic retaining cords is sufficiently elastic to pull and retain a ground support rod in the plurality of ground support rods into a rod receptacle in the plurality of rod receptacles and is sufficiently elastic so that the ground support rod is removable by hand from the rod receptacle.

12. The bird decoy of claim 8, wherein the plurality of ground support rods all extend radially away from the horizontal base within a 180 degree arc and there are no ground support rods extending radially away from the horizontal base outside of the 180 degree arc.

13. The bird decoy of claim 8, wherein the plurality of ground support rods all extend radially away from the horizontal base within a 90 degree arc and there are no ground support rods extending radially away from the horizontal base outside of the 90 degree arc.

14. The bird decoy of claim 8, wherein the stand further comprises:
a spring biased latch attached to an outside surface of the mounting post receptacle, wherein:
the spring biased latch is configured to retain the mounting post receptacle in a vertical position in relation to the horizontal base when an end of the spring biased latch is inserted in a latch receptacle of the horizontal base and
the spring biased latch is configured to enable the mounting post receptacle to pivot with respect to the horizontal base when the spring biased latch is not inserted in the latch receptacle of the horizontal base.

15. A bird decoy comprising:
a simulated bird, wherein the simulated bird includes a mounting post sleeve;
a mounting post having a first end and a second end, wherein the first end of the mounting post is configured to be inserted into the mounting post sleeve of the simulated bird;
a stand comprising:
a horizontal base comprising a plurality of rod receptacles and a latch receptacle,
a plurality of ground support rods configured to be inserted into the plurality of rod receptacles,
a mounting post receptacle comprising a first end configured to receive the second end of the mounting post and a second end pivotally connected to the horizontal base and
a spring biased latch attached to an outside surface of the mounting post receptacle, wherein:
the spring biased latch is configured to retain the mounting post receptacle between a 60 degree and a 120 degree position in relation to the horizontal base when an end of the spring biased latch is inserted in the latch receptacle of the horizontal base and
the spring biased latch is configured to enable the mounting post receptacle to pivot with respect to the horizontal base when the spring biased latch is not inserted in the latch receptacle of the horizontal base.

16. The bird decoy of claim 15, wherein no part of the bird decoy is inserted into the ground.

17. The bird decoy of claim 15, wherein the bird decoy is configured to slide along the ground.

18. The bird decoy of claim 15 further comprising:
a plurality of elastic retaining cords, wherein each elastic retaining cord in the plurality of elastic retaining cords comprises a first end connected to the horizontal base and a second end connected to a ground support rod in the plurality of ground support rods.

19. The bird decoy of claim 15 wherein the plurality of ground support rods all extend radially away from the horizontal base within a 60 degree arc and there are no ground support rods extending radially away from the horizontal base outside of the 60 degree arc.

20. The bird decoy of claim 15 further comprising:
a plurality of elastic retaining cords, wherein each elastic retaining cord in the plurality of elastic retaining cords is sufficiently elastic to pull and retain a ground support rod in the plurality of ground support rods into a rod receptacle in the plurality of rod receptacles and is sufficiently elastic so that the ground support rod is removable by hand from the rod receptacle.
